(19) United States
(12) Patent Application Publication
(10) Pub. No.: US 2013/0226711 A1
(43) Pub. Date: Aug. 29, 2013

(54) MONETIZING IMAGES IN PUBLISHING NETWORKS

(71) Applicants: Ping Wu, Saratoga, CA (US); Guangyu Zhu, Sunnyvale, CA (US)

(72) Inventors: Ping Wu, Saratoga, CA (US); Guangyu Zhu, Sunnyvale, CA (US)

(73) Assignee: GOOGLE INC., Mountain View, CA (US)

(21) Appl. No.: 13/408,494

(22) Filed: Feb. 29, 2012

(51) Int. Cl. G06Q 30/02

(52) U.S. Cl. 705/14.69

(57) ABSTRACT

Methods, systems, and apparatus, including computer programs encoded on a computer storage medium, for monetizing images in publishing networks. In one aspect, a method includes receiving image data associated with a first user identifier. The image data can define an image that depicts, in part an object associated with an advertiser. A definition of a bounded region in which the object is located can be received, where the bounded region is a sub-portion of the image. The image data can be associated with an advertiser. The image data can be provided for presentation on a user device associated with a second user identifier. Selection data indicating a selection of the image within the sub-portion of the image can be received. In response to receiving the selection data, an account associated with the first user identifier can be credited.

### BACKGROUND

This specification relates to advertising, and more specifically to monetizing images depicting an object associated with an advertiser.

Internet social networking services provide a digital medium for users to interact with one another and share information. For example, users are able to distribute digital content (e.g., textual comments, digital images, digital videos, digital audio, hyperlinks to web sites, etc.) to other users that they are connected with in the social networking service.

Image sharing is a very popular aspect of social networking. For example, users upload digital images of their children, pets, or of themselves to share with other users. Many of these uploaded images include an image of a product or other content related to a brand or an advertiser. For example, a user that recently purchased a car may upload images of the car to share with friends.

### SUMMARY

In general, one innovative aspect of the subject matter described in this specification can be embodied in methods that include the actions of receiving, using one or more computing devices, image data associated with a first user identifier, the image data defining an image that depicts, in part, an object associated with an advertiser; receiving, at the one or more computing devices, a definition of a bounded region in which the object is located, the bounded region being a sub-portion of an entire portion of the image; receiving, at the one or more computing devices, an association of the image data with the advertiser; providing the image data for presentation on a user device associated with a second user identifier that is different from the first user identifier; receiving, at the one or more computing devices, from the user device associated with the second user identifier, selection data indicating a selection of the image within the sub-portion of the image; and in response to receiving the selection data, crediting an account associated with the first user identifier. Other embodiments of this aspect include corresponding systems, apparatus, and computer programs, configured to perform the actions of the methods, encoded on computer storage devices.

These and other embodiments can each optionally include one or more of the following features. Receiving the definition of a bounded region in which the object is located, the bounded region being the sub-portion of the entire portion of the image can include: processing, by the one or more computing devices, the image data to detect the object in the image; and determining, by the one or more computing devices, a region of the image having a perimeter that encloses the object in the image as the bounded region.

Aspects can further include causing a device associated with the first user identifier to prompt a user for information identifying the advertiser in response to detecting the object in the image; and receiving the information identifying the advertiser from the device associated with the user identifier.

Receiving the definition of the bounded region in which the object is located, the bounded region being the sub-portion of the entire portion of the image can include receiving data defining the bounded region from a device associated with the first user identifier.

Aspects can further include receiving information identifying the advertiser from the device associated with the first user identifier.

Associating the image with the advertiser can include associating a link to a landing page of the advertiser with the sub-portion of the image. A selection of the sub-portion of the image causes a user device to issue a request for the landing page addressed by the link.

Aspects can further include maintaining an advertisement performance score for the account associated with the user identifier, the advertisement performance score specifying a performance of one or more images as advertisements for a respective object associated with an advertiser; determining whether the advertisement performance score exceeds a performance threshold; and preventing the account associated with the first user identifier from receiving credits in response to determining that the advertisement performance score does not exceed the performance threshold.

Aspects can further include receiving, from the user device associated with the second user identifier, a request for a social networking page of the first user identifier; and providing data to the user device associated with the second user identifier that causes the image to be presented on the social networking page of the first user identifier.

Aspects can further include maintaining a user activity score for the first user identifier, the user activity score being based at least on part on activity of a user associated with the first user identifier within a social networking service hosting the social networking page of the user identifier; determining whether the user activity score exceeds a user activity threshold; and preventing the account associated with the user identifier from receiving credits in response to determining that the user activity score does not exceed the performance threshold. The user activity score can be proportional to a number of social networking acquaintances for the first user identifier.

Aspects can further include associating data with the image that causes the image, once presented, to be highlighted when mouser over.

Aspects can further include determining whether a user associated with the second user identifier is likely to be interested in the object based, at least in part, on profile information for the second user identifier; and associating data with the image that causes the object to be highlighted in the image in response to determining that the user associated with the second user identifier is likely to be interested in the object.

Crediting an account associated with the first user can include crediting the account with an amount determined to be commensurate with the selection.

Particular embodiments of the subject matter described in this specification can be implemented so as to realize one or more of the following advantages. Social networking service providers and/or social networking users, or, more generally, any content publishing network provider and users of the content publishing network, can generate revenue from images depicting an object or other content associated with an advertiser. The providers and/or users can receive a credit in response to a photo depicting an object associated with an advertiser being presented to another user, being selected by another user, or leading to a conversion, such as a purchase of the object depicted in the photo. Advertisers' products can be promoted by promoting images depicting the product in user's photo albums and news feeds or streams. Traffic to an advertiser's social networking page can be increased as a result of images depicting an associated object linking to the advertiser's page. Advertisers can improve their reach to social networking users and provide relevant information, such as product news and updates, to users of the social networking service.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a publishing system enables users to monetize images.

FIG. 2 is flow chart of an example process for monetizing an image.

FIG. 3 is a flow chart of an example process for associating an image for an advertiser.

FIG. 4 is a flow chart of another example process for defining a bounded region around an object in an image.

FIGS. 5A and 5B are interfaces of an example interface for tagging an image with an advertiser.

FIG. 6 is an example social networking interface page for presenting images.

FIG. 7 is an example social networking interface page for presenting images.

Like reference numbers and designations in the various drawings indicate like elements.

### DETAILED DESCRIPTION

### Overview

This document describes a system that enables the monetization of images depicting a brand, product, or other object or entity associated with an advertiser, in a publishing system, such as a social networking system. Users can upload and share images with others using a social networking service. For images depicting an object associated with an advertiser, the users can “tag” the images for the advertiser, which associates the image with the advertiser. For example, a user can upload an image depicting a newly purchased car and tag the image with the manufacturer of the car.

Tagged images may be associated with a link to a web page of an advertiser, such as an advertisement landing page or a social networking page of the advertiser. If the image, or a proper sub-portion thereof, is selected at a user device, the advertiser's web page may be presented to a user of the user device. The linking of tagged images to advertiser's web pages increases traffic to the advertiser's web page.

A credit may be provided to users and/or the social networking service provider in response to an image depicting an object associated with the advertiser being presented to other users and/or actions associated with the images. For example, an advertiser may provide credit for image impressions (e.g., each time the image is viewed by another user), image selections, and/or specified conversions that result from the image being presented.

The amount of the credit provided to the user and/or the social network service provider may depend on the type of interaction with the image. For example, a first amount may be provided for image impressions, a second amount may be provided for an image selection, and yet a third amount may be provided for a conversion. The amount for a conversion can vary based on the type of conversion. The credits for the users can include money, gift cards, upgrade in status with respect to the social networking service, loyalty rewards, free merchandise, discounts, coupons, VIP cards, or other type of credit.

In some implementations, a user can tag an image (or a sub-portion of the image) for an advertiser by drawing a box or other shape around an object associated with the advertiser and selecting or otherwise specifying the advertiser. In some implementations, the system can detect the object in the image and cause the detected object to be highlighted for the user. The user can then tag the image with the advertiser associated with the object by specifying the advertiser or confirming an advertiser predicted by the system.

The system can include analytical tools that enable advertisers to identify and engage users whose images are most effective. For example, the system can maintain and provide to advertisers data regarding image click-through rates, image impressions, numbers of other users reached by a user's social networking page, image conversion rates, and other metrics related to the social network users and their images. Users may be allowed to opt in or opt out of such features.

The system can include safeguards that prevent fraudulent activity with regards to receiving credits for images depicting objects associated with advertisers. In some implementations, only qualified users are eligible to receive credits. For example, the system may determine whether a user is qualified based on their history with the social networking system (e.g., number of contacts in their social circles or years as a member) and/or based on metrics related to the user's images.

In some implementations, access to a user's social networking page, and images associated with the social networking page, may be limited to contacts in the user's social circle. Through the creation and use of social circles, the user can organize and categorize social networking contacts into various different groupings that can be used to control the visibility and access those contacts have to the user's postings, images, videos, audio files, hyperlinks (e.g., uniform resource indicators, URIs), and/or other content associated with the user's social networking profile. As one example, the user can post an image depicting a restaurant visited during a vacation to only a “friends” circle, and spare other contacts within the social networking service from seeing information that is irrelevant to them.

### Example Operating Environment

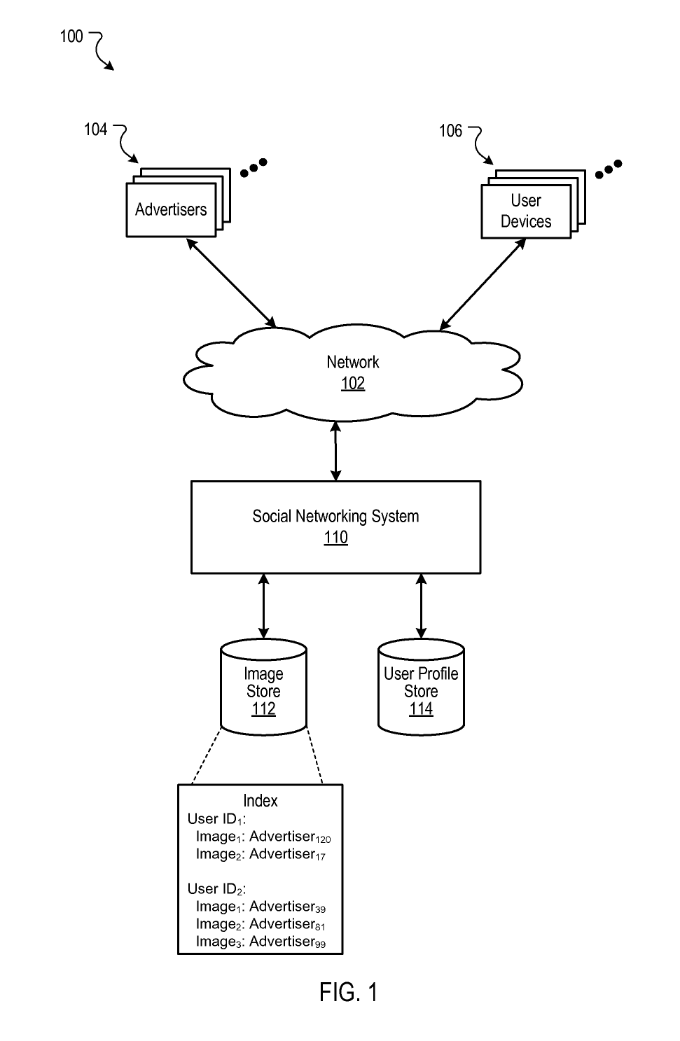

FIG. 1 is a block diagram of an example environment 100 in which a publishing system 110 enables users to monetize images. The publishing system 110 is described in the context of a social networking system 110, but other publishing systems can also be used, such as forum publisher that provides a service in which users register and provide comments and images in discuss threads on various topics.

In the example implementation described below, the publishing system 110 is operated by a social networking service provider and can include one or more computers, such as servers, configured to provide social networking services to users. The environment 100 also includes a number of user devices 106 in data communication with the social networking system 110 by way of a network 102. The network 102 can include a local area network (LAN), wide area network (WAN), the Internet, a mobile phone network, or a combination thereof.

Users of the user devices 106 can access the social networking system 110 to participate in a social networking service. For example, the user devices 106 can include a user application, such as a web browser, that can be used to access the social networking service. In another example, the user devices 106 can include an application that is specific to the social networking service, such as a social networking application for a smartphone or tablet computer. Example user devices 106 include personal computers, mobile communication devices, smartphones, tablet computers, portable media players, televisions having a processor embedded therein or attached thereto, and other devices that can send and receive data over the network 102.

Users interacting with the user devices 106 can participate in the social networking service provided by the social networking system 110 using digital content, such as text comments (e.g., updates, announcements, replies), digital images, videos, audio files, and/or other appropriate digital content. Users can upload content to the social networking system 110 and request social networking pages and other content from the social networking system 110 over the network 102. For example, one user may request the social networking page of another user within one of their social circles from the social networking system 110. In response, the social networking system 110 can provide the social networking page to the user device 106 of the requesting user. In general, social circles are categories to which a user can assign contacts and better control the distribution and visibility of social networking posts and/or other digital content distributed using the social networking service. In some implementations, a social circle can be provided as a data set defining a collection of contacts that are associated with one another in a computer-implemented social networking service. Generally, a social circle can be described from the perspective of an individual that is the center of a particular collection of socially interconnected people, or from the aggregate perspective of a collection of socially interconnected people. A social circle can have narrowly defined boundaries (e.g., members of the social circle might be familiar with one another) and permission may be required for a member to join a social circle. A user of the social networking service can define a social circle. The social circle, as a data set defining a collection of contacts, may reflect real-life social connections and/or interactions of the user. In some implementations, a social circle can be defined by a user as a personal representation or grouping of a set of contacts, the contacts may be unaware of the social circle and/or unaware of other members of the social circle.

The social networking system 110 can maintain an account and profile for each user of the social networking service, for example in a user profile store 114. The user profile for a user can include data about the user, such as contact information, demographic information, likes and interests of the user, information specifying how long the user has been a member of the social networking service, a historical log of interactions with the social networking service, and/or data identifying social circles for the user and contacts within the social circles. The user profile for a user may also include information regarding how well images of the user performs as advertisements in the social networking service, such as click-through rates and conversion rates for the user's images. Each user can be associated with a unique user identifier, and the user profiles can be organized by user identifier.

Generally, users of the social networking service can upload, tag, and share images depicting content or objects associated with advertisers 104 and receive credits for including the images on their social networking page. The advertisers 104 can include businesses, service providers, organizations, groups, locations, or other entities that desire to promote a product, service, event, or other item.

The social networking system 110 can store images received from the user devices 106 in an image data store 112. The data store 112 can include an index that maps images to the users to which the images belong. The index can also include, for each image tagged for an advertiser, information identifying the advertiser, a link to a web page associated with the advertiser, and/or advertisement data. In general, advertisement data for an image can include, among other things, a number of times the image has been presented to other users (e.g., users other than the user that uploaded and tagged the image), a number of times the image has been selected by other users, a number of times that the image led to a conversion, and the types of conversions.

Generally, a conversion occurs when a user performs a specified action. For example, a conversion can occur when a user clicks on the image, is referred to a web page associated with the advertisement, and then consummates a purchase before leaving that web page. Other types of conversions can include a user selecting a “+1” or “like” button that indicates an affinity for the object or the advertiser, or adding the object to a virtual wishlist. For example, the image may presented with an overlay that includes the “+1” button, a button that enables the user to add the object to a virtual wishlist, and/or a button that enables the user to proceed to a web page of the advertiser, such as a social networking fan page or an advertisement landing page.

Advertisers 104 can provide credits for actions taken in response to user images that include content associated with the advertiser 104. In some implementations, credits for the images can be distributed according a revenue share between the social networking service provider and the users. For example, the advertisers 104 may provide payments or other credits to the social networking service provider and/or the users that include the tagged images on their social networking pages.

### Example Process for Image Monetization

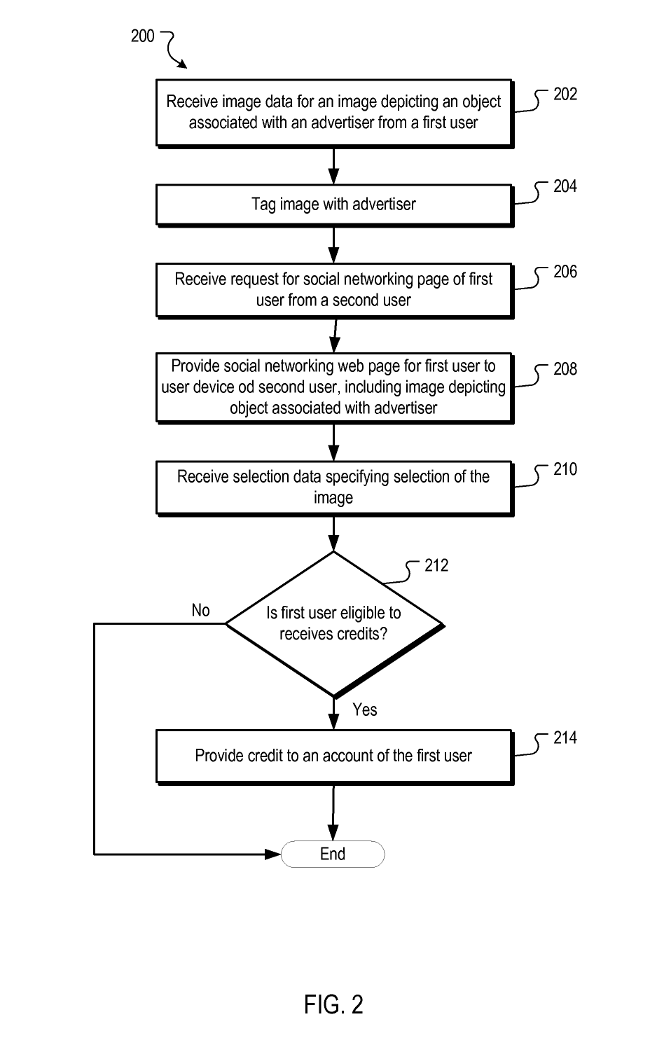

FIG. 2 is flow chart of an example process 200 for monetizing an image. The process 200 results in the providing of credit to an account of a first user in response to a second user selecting an image of the first user that depicts an object associated with an advertiser 104. The process 200 is, for example, implemented in a data processing apparatus of the social networking system 110.

Image data for an image is received (202). For example, a first user operating a user device 106 and having an account with the social networking system 110 may select an image to upload from the user device 106 to the social networking system 110. In response, the user device 106 can transmit image data for the selected image to the social networking system 110. The phrase “image data” as used herein includes its plain and ordinary meaning, including, but not limited to computer-readable data that defines an image and that is sufficient to generate the image for presentation by a computing device.

After receiving the image data, the social networking system 110 can store the image data in the image store 112. The social networking system 110 may also update the index of the image store 112 to include the image and to associate the image with the user identifier of the first user.

The image may depict an object or other content associated with an advertiser 104. For example, the user may upload an image that depicts the user and the user's newly purchased product, such as a car, purse, article of clothing, television, gaming system, or any other type of product. The user, however, need not be in the image. For example, the user may upload a digital photo of a restaurant, landmark, museum, or other location that the user recently visited and which the user took using a digital camera.

The image (or a sub-portion thereof) is tagged for the advertiser 104 of the object depicted by the image (204). The tag can, for example, be a URL of a landing page of the advertiser, or a keyword or some other identifier that uniquely identifies the advertiser. The social networking system 110 may provide manual and semi-automatic processes for associating images with advertisers. A manual process for associating an image with an advertiser 104 can include a user selecting the object associated with the advertiser 104 in the image or defining a bounded region around the object, and specifying the advertiser 104. A semi-automatic process for associating an image with an advertiser 104 can include the social networking system 110 detecting the object or a boundary of the object, causing the object or boundary to be highlighted for the user, and receiving information specifying the advertiser 104 from the user. Example processes for associating an image with an advertiser are described in detail below.

In some implementations, only a sub-portion of the image that includes the object associated with the advertiser 104 is tagged with the advertiser 104. For example, an image can be tagged with multiple entities, including advertisers 104 and social networking contacts. The sub-portion of the image can be defined by a bounded region (e.g., specified by the first user or detected by the social networking system 110) that encloses the object associated with the advertiser 104. After the image is tagged, data describing the association with the advertiser, any appropriate sub-portions of the image, and the user identifier are stored in the image store 112, as depicted in FIG. 1.

A request is received for a social networking page of the first user (206). For example, a second user operating another user device 106 may request to view a social networking page of the first user. The requested social networking page may include the image tagged with the advertiser 104. For example, the second user may request an image or photo album page of the first user that contains the image.

The social networking page of the first user is provided to the user device 106 of the second user (208). Once received, the user device 106 can present the social networking page, including the image, to the second user.

In some implementations, objects associated with an advertiser 104 may be highlighted in tagged images when the images are displayed. For example, the object may be highlighted in response to a user “mousing over” the object or “hovering” over the object for a predetermined period of time. As used herein, the phrase “mousing over” and the term “hovering” include their plain and ordinary meaning, including, but not limited to placing, and optionally maintaining, a cursor, such as a mouse cursor or other pointer, over an object presented on a display.

In some implementations, the social networking system 110 may determine or predict whether a user viewing the image may be interested in the object and cause the object to be highlighted if the user may be interested in the object. The social networking system 110 may evaluate the user profile for the user to determine whether the user may be interested in the object. For example, if the user has shown an affinity for an image, message, post, or other content related to the object or the advertiser 104 tagged in the image, this information may be stored in the user's profile and used to determine that the user may be interested in the object. Other profile information also can be used in some implementations, such as demographic information (e.g., age, gender, education, etc.), location information (e.g., information identifying the user's current geographic location), and information regarding contacts in the user's social circle(s).

In some implementations, objects associated with an advertiser 104 depicted in an image may be highlighted only if the social networking system 110 determines with at least a threshold level of confidence that the user viewing the image may be interested in the object. This feature can help prevent users from being overburdened with advertising content in which the user may not be interested, and reduces the likelihood of ad blindness.

Selection data specifying the selection of the image is received (210). For example, the social networking system 110 may receive the selection data from the user device 106 of the second user. The phrase “selection data” as used herein includes it plain and ordinary meaning, including, but not limited to data specify that a selection of an image has occurred and/or what portion of the image was selected. For example, the selection data may specify that the second user selected the sub-portion of the image tagged with the advertiser 104. Or, the selection data may specify that the second user selected a button depicted on an overlay for the image, such as a “+1” or “like” button, a button for adding the object to a virtual wishlist, and/or a button for requesting a web page of the advertiser 104.

In some implementations, the image may be associated with a link to web page of the advertiser 104 and the web page of the advertiser 104 may be provided to the second user in response to certain selections. For example, if the second user selects the image within the sub-portion of the image tagged with the advertiser 104 or a button for requesting the web page of the advertiser 104, then the web page of the advertiser 104 may be provided to the second user. By way of another example, if any portion of the image is selected, the web page of the advertiser 104 may be provided to the second user. As described above, the web page of the advertiser 104 may be a social networking page of the advertiser 104, such as a fan page hosted by the social networking system 110. Or, the web page of the advertiser 104 may be a landing page associated with the object depicted by the image. In some implementations, the advertisers 104 may be able to specify the web page referred by the image.

In some implementations, the advertiser 104 can provide a URL that is to be associated with any images tagged with the advertiser 104. For example, the advertiser 104 may specify that images tagged with the advertiser 104 link to the advertiser's social networking fan page or to a landing page of the advertiser's choice. In some implementations, users may be limited to associating the URL provided by the advertisers with tagged images, for example to prevent users from linking images tagged with advertisers to resources that are not associated with the tagged advertiser.

A determination is made whether the first user is eligible to receive credits for the selection (or the impression) of the image (212). In some implementations, credits are only provided to qualified users to prevent fraudulent clicks and impressions and to ensure that the users are real users of the social networking service. The social networking system 110 can determine whether a user is a qualified user based on the user's history with the social networking system 110 (e.g., number of contacts in their social circles or length of time as a member) and/or based on metrics related to the user's images.

In some implementations, the social networking system 110 may determine a user activity score for the user. The user activity score may be based on the length of time that user has been a member of the social networking service and/or the number of contacts within the user's social circle(s). The social networking service 110 can compare this user activity score to a user activity threshold and, if the user activity score exceeds the user activity threshold, the user may be considered a qualified user. Other social networking history of the user may also factor into the user activity score, such as a time period since the user last accessed the social networking service and a number of message posts over a certain time period.

In some implementations, the number of images uploaded by a user that are tagged for an advertiser 104 can be used to determine whether the user is a qualified user. For example, if a large portion of the images have been tagged for an advertiser, that user may not be considered qualified as one or more users may be using a single account on the social networking system simply to capitalize on image impressions. If a fraction of the number of the user's images that are tagged for an advertiser 104 to the total number of images of the user is below a threshold, the user may be considered a qualified user.

In some implementations, a conversion rate for a user's images tagged for an advertiser 104 may be used to determine whether the user is a qualified user. The phrase “conversion rate” as used herein for images includes its plain and ordinary meaning, including, but not limited to the number of conversions resulting from users selecting the image divided by the number of user selections of the image. For example, if the images of the user receive a large number of selections, but do not result in a purchase, the user may not be considered a qualified user. In some implementations, a count of the number of short clicks or click reversions with respect to the images tagged for an advertiser 104 may be used to determine whether the user is a qualified user. For example, if users typically revert back to the social networking page of the first user after selecting an image and visiting the web page of the advertiser, the first user may not be considered a qualified user. Other signals of low quality clicks can also be used to determine whether a user is a qualified user.

If the first user is not a qualified user and is not eligible to receive credits, the process 200 ends. If the first user is a qualified user, a credit is provided to an account of the first user. As described above, the credit provided to a user may include money, gift cards, upgrade in status with respect to the social networking service, loyalty rewards, free merchandise, discounts, coupons, VIP cards, or other type of credit, and the amount of the can be based on the second user's action with respect to the image. For example, differing amounts of credit may be provided for a selection of the image at the sub-portion of the image depicting the object, a selection of a “+1” or “like” button, a selection of a wishlist button, and for a purchase of a product offered by the advertiser 104. In some implementations, a credit is provided to the account of the first user based on the second user viewing the second image, without a requirement that the second user interact with the image.

The social networking system 110 can facilitate crediting users for images depicting an object associated with an advertiser 104, for example utilizing a revenue share between the social networking service provider and the users. For example, the social networking system 110 may log image impressions, image selections, and image conversions for each user and for each image tagged for an advertiser 104. The social networking system 110 may request and receive payments for the social networking service provider from the advertisers 104 based on the logged information. The social networking system 110 may also request credits for the users based on the logged information. For example, the social networking system 110 may request and receive credits for the users from the advertisers 104 and provide the credits to the users based on activity with respect to each respective user's images. Or, the advertisers 104 may provide the credits directly to the users.

In some implementations, an advertiser 104 can specify the amount of credits the advertiser 104 is willing to provide for images depicting an object associated with the advertiser 104. For example, the advertiser 104 may specify an amount for an image impression, an amount for an image selection, and an amount for each type of conversion. This information can be provided to the users, for example when the users are tagging the images.

In some implementations, the amount of credit depends on the quality of the image with respect to the object associated with the advertiser 104. For example, a blurry image or an image in which the object is small relative to the image may not be good candidates for use as advertisements and may not be eligible for the same amount of credit as an image that depicts the object clearly and prominently. In some implementations, the advertiser 104 may preview images and set the credit amount(s) or elect not to provide credits based on the image.

In some implementations, power users may receive a larger credit amount than other users. For example, a user that has a larger number of social networking contacts and/or has a high degree of influence may receive larger credit amounts than other users that are not power users. These power users may also be provided additional incentives to include images depicting advertisers' objects on their social networking page.

In some implementations, advertisers 104 may be provided tools that enable them to identify power users or other users that may be effective in advertising their products through social networking images. For example, with the users' permission, the social network system 110 may identify users having a large number of social networking contacts and/or high image performance measures with respect to advertising (e.g., conversion rates, click-through rates, etc.). The advertisers 104 can offer incentives to these users to include images that depict their products on their social networking page.

In some implementations, advertisements may be presented on the social networking page along with the image. For example, the social networking system 110 may select or request advertisements (e.g., from the advertiser 104 or another entity) that are related to the advertiser 104 and/or the object and present the advertisements on the social networking page when the image is presented. The advertisements may be presented at the top of the page, at the bottom of the page, on one side of the page, or adjacent to the image. Credits may be provided to the user and/or social networking service provider in response to impressions and selections of these advertisements and/or for conversions resulting from the advertisements.

In some implementations, an advertiser may be allowed to preview an image with which it is associated prior to the association being made available to other users. For example, a user may upload and tag an image, and the image may be posted on the user's social network page. However, until the advertiser with which the image is associated approves of the association, the providing of additional advertising content by means of the association, and providing credits to the user, are precluded.

In some implementations, the social networking system 110 can assist advertisers 104 in gaining social networking users as fans and enable the advertisers 104 to interact with the users. When a user becomes a fan of the advertiser 104 (e.g., by selecting a “+1” or “like” button), the social networking system 110 may enable the advertiser 104 to communicate with the user, for example to send brand news and product updates. For example, a first user may view images tagged with advertisers 104 that are published on a second user's social networking page. The first user may select one of the images and be referred to the social networking fan page of the associated advertiser 104. At the social networking brand page, the first user may select a “+1” button and become a social networking fan (or other type of contact) of the advertiser 104. The social networking system 110 may then enable the advertiser 104 to send messages to the first user. Additionally, or in the alternative, the social networking system 110 may promote the advertiser 104 or the advertiser's brand page to the second user in an attempt to get the second user to also become a fan of the advertiser 104.

### Example Processes for Tagging Images for Advertisers

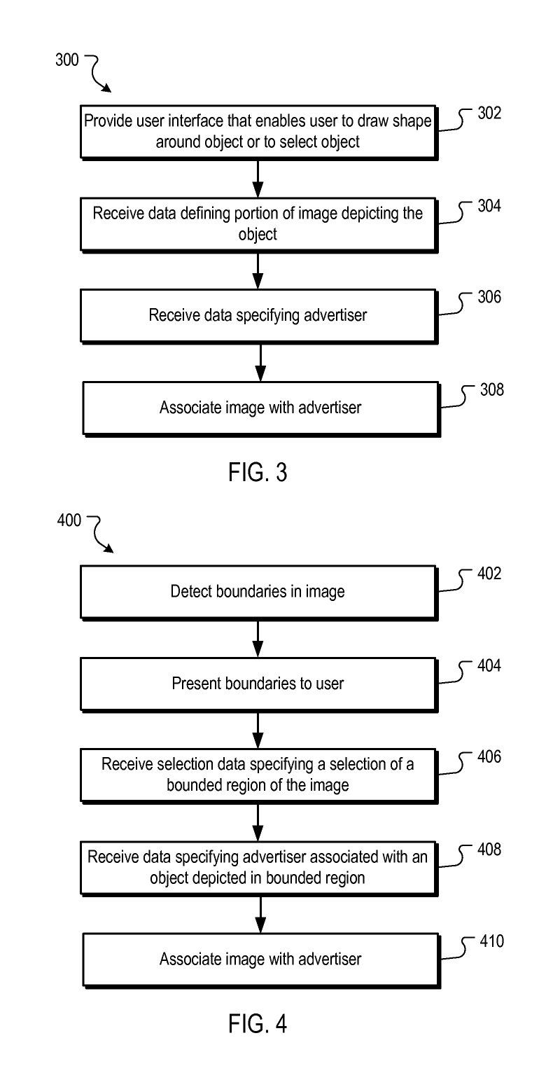

FIG. 3 is a flow chart of an example process 300 for tagging an image for an advertiser 104. The process 300 is, for example, implemented by a data processing apparatus of the social networking system 110.

A user interface is provided that presents the image and enables a user to draw a shape, such as a box, around an object depicted by the image that is associated with the advertiser 104 (302). For example, the social networking system 110 may embed the user interface in a web page and provide the web page to the user device 106 of the user. In some implementations, rather than draw a shape around the object, the user may select, e.g., using a mouse, the image at or near the object.

Information defining the portion of the image depicting the object is received (304). For example, the user device 106 may provide to the social networking system 110 information specifying the portion of the image enclosed by the user drawn shape or the point on the image at which the user selected.

Information specifying the advertiser 104 is received (306). In some implementations, a list of advertisers 104 that provide credits to users is provided by the user interface. The user can select the appropriate advertiser 104 from the list and the user device 106 can send information specifying the selected advertiser 104 to the social networking system 110.

In some implementations, a text entry field may be presented to the user so that the user can enter the name of the advertiser 104 and the entered name is provided to the social networking system 110. The social networking system 110 can compare the entered name to a list of participating advertisers 104 and confirm to the user whether the advertiser 104 is a participant. If the user specified advertiser is not a participant, then the image may not be tagged with the user specified advertiser in some implementations as that advertiser may not have opted in to provide credits.

The image is associated with the advertiser 104 specified by the user (308). For example, the social networking system 110 may update the index of the image store 112 to indicate that the image is associated with the selected advertiser 104. In some implementations, only the sub-portion of the image defined by the user is associated with the selected advertiser 104. For example, the image may be tagged with one or more advertisers 104 if the image contains multiple objects associated with advertisers 104. Or, the image may also be tagged with social networking contacts of the user that are depicted in the image. If only the sub-portion of the image is associated with the advertiser 104, information specifying the sub-portion may also be specified in the index of the image store 112.

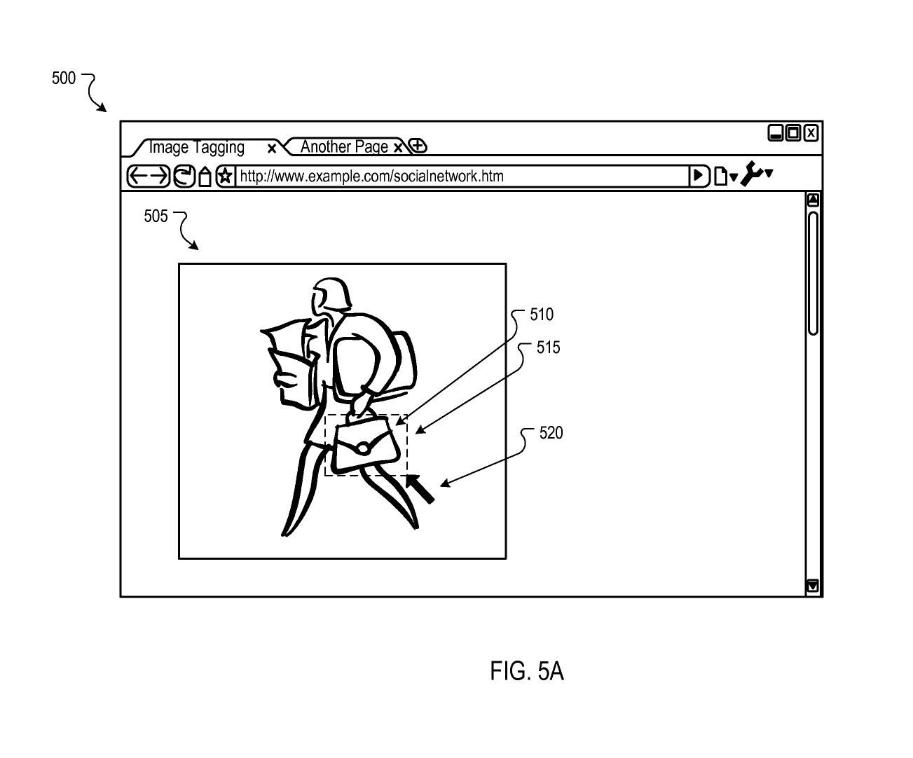

FIG. 4 is a flow chart of an example semi-automatic process 400 for tagging an image with an advertiser 104. The process 400 is, for example, implemented in a data processing apparatus of the social networking system 110. Boundaries in the image are detected (402). The social networking system 110 can utilize image segmentation and object boundary detection techniques to detect the boundaries in the image based on the image data for the image. In some implementations, the social networking system 110 utilizes object detection techniques to detect objects and their boundaries in the image. Some exemplary object detection techniques include edge detection, interest point detection, corner detection, blob detection, ridge detection, Hough transform, affine invariant feature detection, and scale-invariant feature transform (“SIFT”) techniques.

In some implementations, the social networking system 110 utilizes object segmentation techniques to segment to partition the image into multiple segments and to locate objects and boundaries in the image. Some exemplary image segmentation techniques include thresholding, clustering (e.g., K-means clustering), compression-based segmentation, histogram-based segmentation, edge detection, region-growing, split-and-merge, partial differential equation-based segmentation, graph partitioning segmentation, watershed transformation, and model-based segmentation.

Boundaries detected in the image are presented to the user (404). For example, the social networking system 110 may provide image data to the user device 106 of the user that defines the image with highlighted boundaries and the user device 106 can present the image with the boundaries highlighted to the user. The boundaries can be highlighted by bold lines, dashed lines, or other types of highlighting. In some implementations, a bounded region of the image may be highlighted, for example in response to a user mousing over the bounded region. For example, the bounded region may be highlighted with bold lines illustrating the boundary or by presenting a larger version of the bounded region in response to the user mousing over the bounded region.

Selection data specifying a selection of a bounded region is received (406). For example, the user device 106 may provide the selection data to the social networking system 110 in response to the user selecting one of the bounded regions. The selection data can identify the bounded region of the image selected by the user.

Data specifying the advertiser 104 associated with an object depicted in the bounded region is received (408). For example, a list of participating advertisers 104 may be presented to the user in response to the user selecting one of the bounded regions of the image. If the advertiser 104 associated with the object depicted in the bounded region is included in the list, the user can select the appropriate advertiser 104. In turn, the user device 106 can provide data specifying the selected advertiser 104 to the social networking system 110. In some implementations, a text entry field may be provided to the user device 106 so that the user can enter the name of the advertiser 104, as described above.

In some implementations, the social networking system 110 can determine or predict the object within the bounded region. The social networking system 110 may use optical character recognition to identify brand names or other text in the bounded region that may be associated with an advertiser 104. For example, the bounded portion of the image may include a product label (e.g., on a soda bottle) or a designer label (e.g., on an article of clothing). Any identified text can be compared to an index of text for each advertiser 104 to determine whether there is a match. If a match is found, the social networking system 110 can provide a list of candidate advertisers 104 that match the text and the user can select the advertiser 104 from the list.

In another example, the social networking system 110 can use image features (e.g., shapes, colors, texture, etc.) of the portion of the image to attempt to identify the object in the bounded region. For example, car emblems typically have a unique shape. If that shape is detected, the social networking system 110 can identify the manufacturer of the car as a candidate advertiser for the object.

The image, or the bounded region of the image, is associated with the advertiser specified by the user (410). For example, the social networking system 110 may update the index of the image store 112 to indicate that the image and/or the bounded region of the image is associated with the selected advertiser 104.

### Example Interfaces

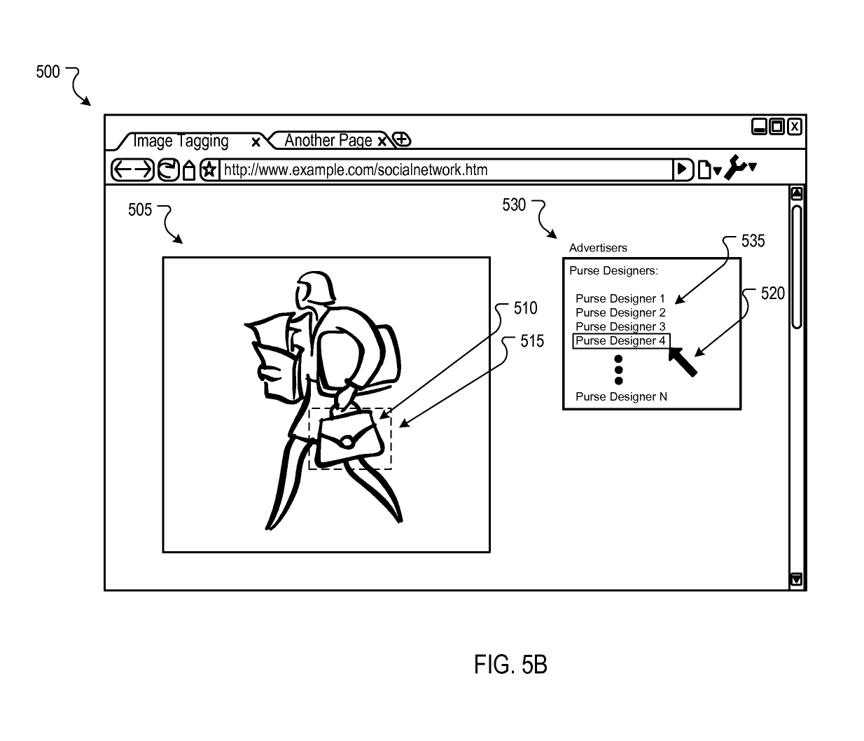

FIGS. 5A and 5B are interfaces of an example interface 500 for tagging an image 505 with an advertiser. The image 505 displayed in the interface depicts, in part, an object associated with an advertiser. In particular, the image 505 depicts a purse 510 that is being carried by a lady and marketed by a purse designer. To associate the image 505 and/or the purse 510 with the purse designer, the user can either select the purse, e.g., using a mouse or other pointer, or draw a shape around the purse 510. In FIG. 5A, the user has drawn a box 515 around the purse 510 by clicking and dragging a mouse cursor 520 until the box enclosed the purse 505.

After the portion of the image that depicts the purse 510 has been defined by the box 515, a list of advertisers 530 may be presented to the user so that the user can select the appropriate advertiser, as shown in FIG. 5B. The example list 530 includes several purse designers 535 for the user to select from, for example using the mouse cursor 520. To get to this particular list 505 that identifies purse designers, the user may specify that the object is a purse, or the social networking system 110 may detect that the object enclosed by the box 515 is likely a purse.

In this example, the user has selected “Purse Designer 4.” Data specifying the selection of “Purse Designer 4” can be sent from the user device presenting the interface 500 to the social networking system 110 and the social networking system 110 can associate the image 505 or the portion of the image 505 enclosed by the box 515 with “Purse Designer 4.”

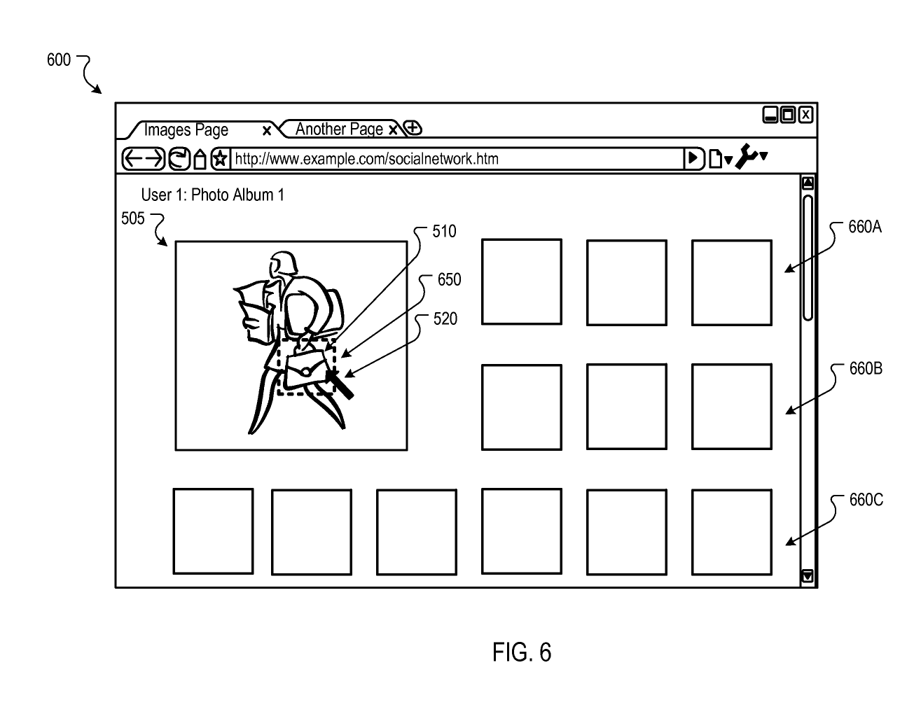

FIG. 6 is an example social networking interface page 600 for presenting images. In particular, the example social networking page 600 is a photo album for “User 1.” Included in the photo album are a multitude of images 660 and the image 505 of the lady carrying the purse 510. The currently selected image may be presented in a larger size than the other images. For example, the image 505 is larger than the other images 660.

As shown in FIG. 6, the purse 610 is highlighted with a box 650 that encloses the purse 510. The box 610 may be presented (or the purse 510 may be highlighted in another way) in response to the user viewing the social networking page 600 mousing over the purse 510 or the portion of the image defined by the box 515 in FIGS. 5A and 5B. Or, the purse 510 (or image portion defined by the box 510) may be highlighted in response to the social networking system 110 determining that the user viewing the social networking page 600 may be interested in the purse, as described above.

The other images 660 may be organized based on whether the images 660 are tagged for an advertiser 104. For example, images tagged for an advertiser 104 may be promoted to other users that view the images of “User 1.” The top row of images 660A may be images tagged for an advertiser 104, while the other rows of images 660B and 660C are images that have not been tagged for an advertiser 104. In some implementations, tagged images may be organized based on the amount of credit the advertisers 104 associated with the images have promised to provide in response to the image being presented, selected, or resulting in a conversion. For example, images associated with advertisers 104 that provide the greatest amount of credit may be presented in higher rows than images associated with advertisers that provide a lesser amount of credit.

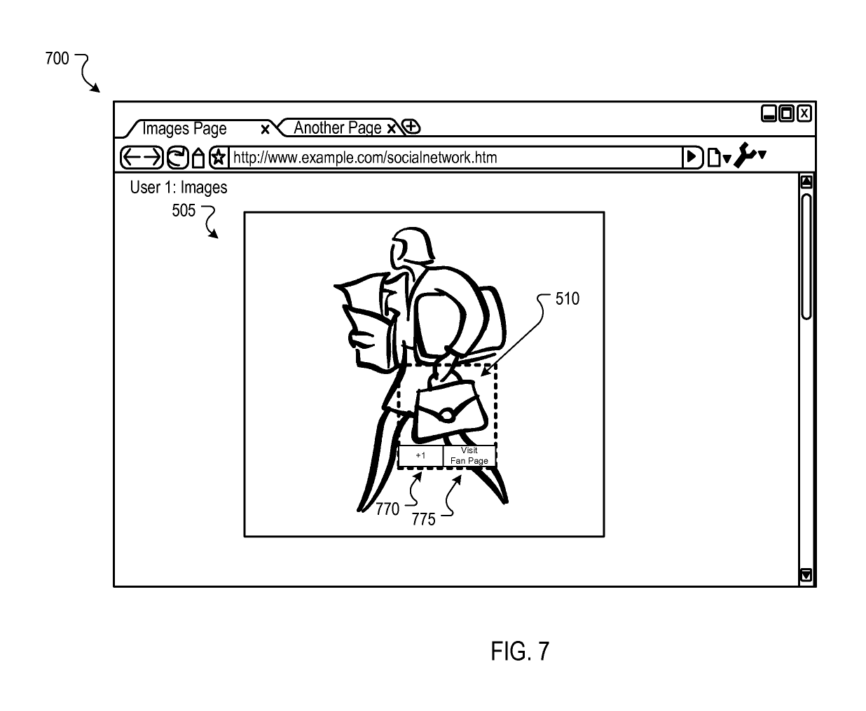

FIG. 7 is an example social networking interface page 700 for presenting images. In this interface 700, the image 505 of the lady carrying the purse 510 includes an overlay having a “+1” button 770 and a “Visit Fan Page” button 775. If the user viewing the social networking page 700 selects the “+1” button 770, a count of the number of users that like the social networking fan page of “Purse Designer 4” tagged in the image 770 may be incremented. Additionally, a credit may be provided to an account of “User 1” and/or the social networking service provider in response to the selection.

If the user viewing the social networking page 700 selects the “Visit Fan Page” button 775, the social networking fan page of “Purse Designer 4” tagged in the image may be presented to the user. Additionally, a credit may be provided to an account of “User 1” and/or the social networking service provider in response to the selection.

Although the example operating environment and the examples processes discussed above has been discussed in terms of social networking images, images shared using other types of web sites, e.g., image sharing sites, blogs, message boards, etc., can also be monetized using the processes described herein. Furthermore, although the specification has been organized using headers, features described under a heading may not be limited to the implementation described under that heading and instead may apply to implementations described under other headings.

### Additional Example Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computing devices, the method comprising:
receiving, using the one or more computing devices, image data associated with a first user identifier, the image data defining an image that depicts, in part, an object associated with an advertiser;
receiving, at the one or more computing devices, a definition of a bounded region in which the object is located, the bounded region being a sub-portion of an entire portion of the image;
receiving, at the one or more computing devices, an association of the image data with the advertiser;
providing the image data for presentation on a user device associated with a second user identifier that is different from the first user identifier;
receiving, at the one or more computing devices, from the user device associated with the second user identifier, selection data indicating a selection of the image within the sub-portion of the image; and
in response to receiving the selection data, crediting an account associated with the first user identifier.

2. The method of claim 1, wherein receiving the definition of a bounded region in which the object is located, the bounded region being the sub-portion of the entire portion of the image comprises:
processing, by the one or more computing devices, the image data to detect the object in the image; and
determining, by the one or more computing devices, a region of the image having a perimeter that encloses the object in the image as the bounded region.

3. The method of claim 2, further comprising:
causing a device associated with the first user identifier to prompt a user for information identifying the advertiser in response to detecting the object in the image; and
receiving the information identifying the advertiser from the device associated with the user identifier.

4. The method of claim 1, wherein receiving the definition of the bounded region in which the object is located, the bounded region being the sub-portion of the entire portion of the image comprises receiving data defining the bounded region from a device associated with the first user identifier.

5. The method of claim 4, further comprising receiving information identifying the advertiser from the device associated with the first user identifier.

6. The method of claim 1, wherein associating the image with the advertiser comprises associating a link to a landing page of the advertiser with the sub-portion of the image, wherein a selection of the sub-portion of the image causes a user device to issue a request for the landing page addressed by the link.

7. The method of claim 1, further comprising:
maintaining an advertisement performance score for the account associated with the user identifier, the advertisement performance score specifying a performance of one or more images as advertisements for a respective object associated with an advertiser;
determining whether the advertisement performance score exceeds a performance threshold; and
preventing the account associated with the first user identifier from receiving credits in response to determining that the advertisement performance score does not exceed the performance threshold.

8. The method of claim 1, further comprising:
receiving, from the user device associated with the second user identifier, a request for a social networking page of the first user identifier; and
providing data to the user device associated with the second user identifier that causes the image to be presented on the social networking page of the first user identifier.

9. The method of claim 8, further comprising:
maintaining a user activity score for the first user identifier, the user activity score being based at least on part on activity of a user associated with the first user identifier within a social networking service hosting the social networking page of the user identifier;
determining whether the user activity score exceeds a user activity threshold; and
preventing the account associated with the user identifier from receiving credits in response to determining that the user activity score does not exceed the performance threshold.

10. The method of claim 9, wherein the user activity score is proportional to a number of social networking acquaintances for the first user identifier.

11. The method of claim 1, further comprising associating data with the image that causes the image, once presented, to be highlighted when mouser over.

12. The method of claim 1, further comprising:
determining whether a user associated with the second user identifier is likely to be interested in the object based, at least in part, on profile information for the second user identifier; and
associating data with the image that causes the object to be highlighted in the image in response to determining that the user associated with the second user identifier is likely to be interested in the object.

13. The method of claim 1, wherein crediting an account associated with the first user comprises crediting the account with an amount determined to be commensurate with the selection.

14. A system, comprising:
a processing apparatus;
a memory storage apparatus in data communication with the data processing apparatus, the memory storage apparatus storing instructions executable by the data processing apparatus and that upon such execution cause the data processing apparatus to perform operations comprising:
receiving image data associated with a first user identifier, the image data defining an image that depicts, in part, an object associated with an advertiser;
receiving a definition of a bounded region in which the object is located, the bounded region being a sub-portion of an entire portion of the image;
receiving an association of the image data with the advertiser;
providing the image data for presentation on a user device associated with a second user identifier that is different from the first user identifier;
receiving, from the user device associated with the second user identifier, selection data indicating a selection of the image within the sub-portion of the image; and
in response to receiving the selection data, crediting an account associated with the first user identifier.

15. The system of claim 14, wherein receiving the definition of a bounded region in which the object is located, the bounded region being the sub-portion of the entire portion of the image comprises:
processing the image data to detect the object in the image; and
determining a region of the image having a perimeter that encloses the object in the image as the bounded region.

16. The system of claim 15, wherein the instructions upon execution cause the data processing apparatus to perform further operations comprising:
causing a device associated with the first user identifier to prompt a user for information identifying the advertiser in response to detecting the object in the image; and
receiving the information identifying the advertiser from the device associated with the user identifier.

17. The system of claim 14, wherein receiving the definition of the bounded region in which the object is located, the bounded region being the sub-portion of the entire portion of the image comprises receiving data defining the bounded region from a device associated with the first user identifier.

18. The system of claim 17, wherein the instructions upon execution cause the data processing apparatus to perform further operations comprising receiving information identifying the advertiser from the device associated with the first user identifier.

19. A computer storage medium encoded with a computer program, the program comprising instructions that when executed by data processing apparatus cause the data processing apparatus to perform operations comprising:
receiving image data associated with a first user identifier, the image data defining an image that depicts, in part, an object associated with an advertiser;
receiving a definition of a bounded region in which the object is located, the bounded region being a sub-portion of an entire portion of the image;
receiving an association of the image data with the advertiser;
providing the image data for presentation on a user device associated with a second user identifier that is different from the first user identifier;
receiving, from the user device associated with the second user identifier, selection data indicating a selection of the image within the sub-portion of the image; and
in response to receiving the selection data, crediting an account associated with the first user identifier.

20. The computer storage medium of claim 19, wherein receiving the definition of a bounded region in which the object is located, the bounded region being the sub-portion of the entire portion of the image comprises:
processing the image data to detect the object in the image; and
determining a region of the image having a perimeter that encloses the object in the image as the bounded region.

21. The computer storage medium of claim 20, wherein the instructions upon execution cause the data processing apparatus to perform further operations comprising:
causing a device associated with the first user identifier to prompt a user for information identifying the advertiser in response to detecting the object in the image; and
receiving the information identifying the advertiser from the device associated with the user identifier.

22. The computer storage medium of claim 19, wherein receiving the definition of the bounded region in which the object is located, the bounded region being the sub-portion of the entire portion of the image comprises receiving data defining the bounded region from a device associated with the first user identifier.

23. The computer storage medium of claim 22, wherein the instructions upon execution cause the data processing apparatus to perform further operations comprising receiving information identifying the advertiser from the device associated with the first user identifier.
